(19) United States
(12) Patent Application Publication
(10) Pub. No.: US 2015/0156156 A1
(43) Pub. Date: Jun. 4, 2015

(54) SYSTEM AND METHOD FOR MANAGING CONTACT INFORMATION REQUESTS

(71) Applicant: Talk.to FZC, Ras Al Khaimah (AE)

(72) Inventor: Bhavin Turakhia, Mumbai (IN)

(73) Assignee: Talk.to FZC, Ras Al Khaimah (AE)

(21) Appl. No.: 14/370,469

(22) PCT Filed: Dec. 2, 2013
(86) PCT No.: PCT/IN2013/000733

§ 371 Date: Jul. 2, 2014

(51) Int. Cl. H04L 12/58

(52) U.S. Cl. CPC H04L 51/22

(57) ABSTRACT

In example embodiments, a system and method for managing contact information requests in a network are provided. Accordingly, a request is received at a contact management system from a user device of a user. The request is for a value for a contact that corresponds to an individual in an address book of the user. An electronic message is sent to and an electronic response received from the individual. Based on the electronic response being a reply in a same format as the electronic message and the reply including the value, the reply is parsed to obtain the value. Based on the electronic response being an indication of activation of a link provided in the electronic message, a form is provided with a field for entering the value. The value obtained from the individual may be automatically provided to the user for updating of their address book.

### FIELD

The present disclosure relates generally to management of address books, and in a specific example embodiment, to managing contact information requests in a network.

### BACKGROUND

Typically, an individual may have a plurality of contact mechanisms that enable the individual to be reachable via multiple networks. For example, the individual may have a Facebook account, a Gmail account, and a mobile number. Social contacts of the individual (e.g., friends, colleagues) may have address books that contain one or more of the contact mechanisms (e.g., contact entries or information such as a mobile number) for the individual. However, in some cases, the social contact may require a particular contact mechanism that does not exist in their address book.

### BRIEF DESCRIPTION OF DRAWINGS

Various ones of the appended drawings merely illustrate example embodiments of the present invention and cannot be considered as limiting its scope.

FIG. 1 is a diagram illustrating an example environment in which embodiments of a system for managing contacts in a network may be implemented.

FIG. 2 is a block diagram illustrating an example embodiment of a contact management system.

FIG. 3 is a flow diagram of an example a method for managing contact information requests in a network.

FIG. 4 is a flow diagram of an example method for obtaining the contact information from a reply provided by an individual.

FIG. 5 is a flow diagram of an example method for provisioning obtained contact information to socially connected users.

FIGS. 6A and 6B is a communication flow diagram of an example method for managing contact information requests in the network.

FIG. 7 is a simplified block diagram of a machine in an example form of a computing system within which a set of instructions for causing the machine to perform any one or more of the methodologies discussed herein may be executed.

### DETAILED DESCRIPTION

The description that follows includes systems, methods, techniques, instruction sequences, and computing machine program products that embody illustrative embodiments of the present invention. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general well-known instruction instances, protocols, structures, and techniques have not been shown in detail.

Example embodiments described herein provide systems and methods for managing contact information requests in a network. In example embodiments, a user sends a request for contact information (also referred to as a “value”) for a contact in the user's address book. The contact corresponds to an individual that may be socially connected to the user. Assuming the value does not exist in a primary profile corresponding to the individual, an electronic message is sent to the individual. The individual may then provide an electronic response. Based on the electronic response being a reply in a same format as the electronic message (e.g., an e-mail, text) and the reply including the requested value, the reply is parsed to obtain the value. Alternatively, based on the electronic response being an activation of a link provided in the electronic message, a form is provided to the individual that includes a field for entering the value. The value is then obtained from the field once the individual fills in and submits the value. The value may be automatically transmitted and added to the address book of the user. Additionally, the value may be automatically provided to a permission set of users (e.g., social contacts) that the individual indicated should automatically receive the value.

By using embodiments of the present invention, contacts in address books may be automatically updated. Accordingly, one or more of the methodologies discussed herein may obviate a seed for manual user input in order to update a contact in the address book. This may have the technical effect of reducing computing resources used by one or mote devices within the system. Examples of such computing resources include, without limitation, processor cycles, network traffic, memory usage, storage space, and power consumption.

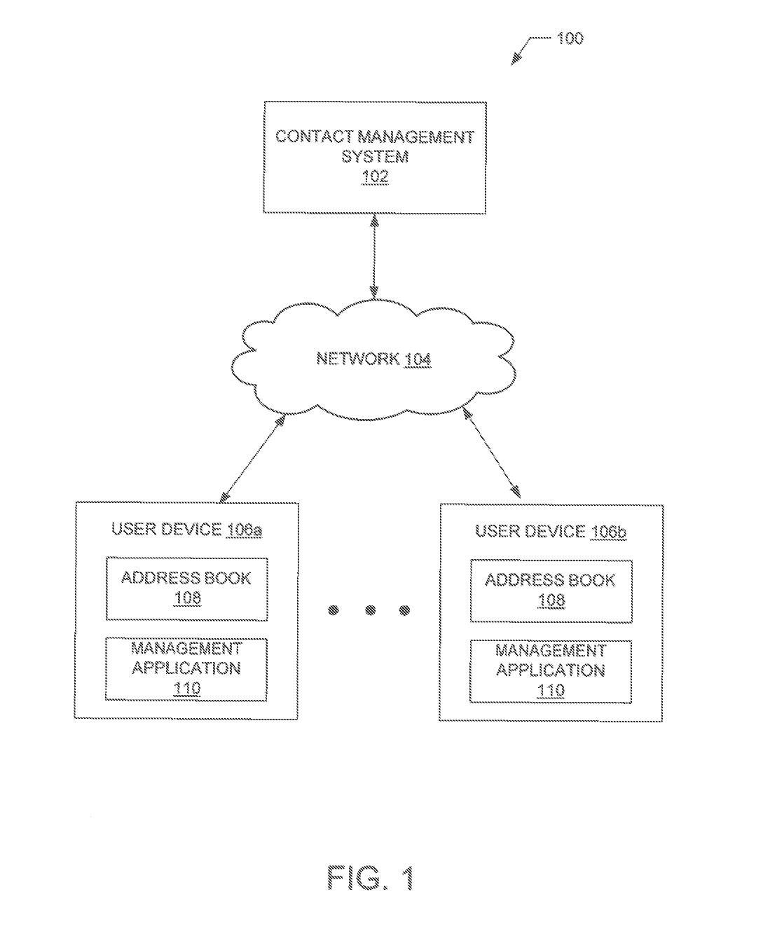

With reference to FIG. 1, a diagram illustrating an example environment 100 in which embodiments of a system for managing contact information requests is shown. The environment 100 comprises a contact management system 102 coupled via a network 104 (e.g., the Interact, wireless network, cellular network, or a Wide Area Network (WAN)) to a plurality of user devices 106 comprised of a user device 106a, a user device 106b, and the like. Each user device 106 is associated with a user that maintains an address book 108 in their respective user device 106. The user device 106 may comprise a mobile phone, laptop, tablet, or any other communication device that a user may utilize to store, access, or manage the address book 108. The address book 108 comprises a data store of contact information for the user. The address book 108 is a contact list having a plurality of contacts (e.g., entries in the address book 108) whereby each contact contains one or more values (e.g., address, e-mail, phone number) that enable communication with an individual corresponding to the entry. It is noted that the terms “address book” and “contact list” may be used interchangeably.

In example embodiments, a management application 110 is provisioned from the contact management system 102 to the user device 106. For example, when the user of the user device 106 initially signs up for service from the contact management system 102, the management application 110 may be provided to the user device 106. The management application 110 may be provided, for example hut not limited to, by the user device downloading the management application 110, the management application 110 being electronically sent to the user device, or the management application 110 being physically sent to the user.

Once the management application 110 is activated on the user device 106, the management application 110 may exchange information with the contact management system 102. In example embodiments, the management application 110 allows the user to send a request for a value for a contact in the address book 108. For example, the user may have an email for a contact, but be missing a mobile number in the address book 108. The management application 110 may receive new values that are confirmed by the individual that is used to update the contact for the individual in the address book 108.

It is noted that the environment 100 shown in FIG. 1 is exemplary. Example alternative embodiments may comprise any number of contact management systems 102 and user devices 106 in communication in the environment 100. Furthermore, while the address book 108 is shown as being located within the user device 106, in some embodiments, the user device 106 may access a remotely stored address book 108.

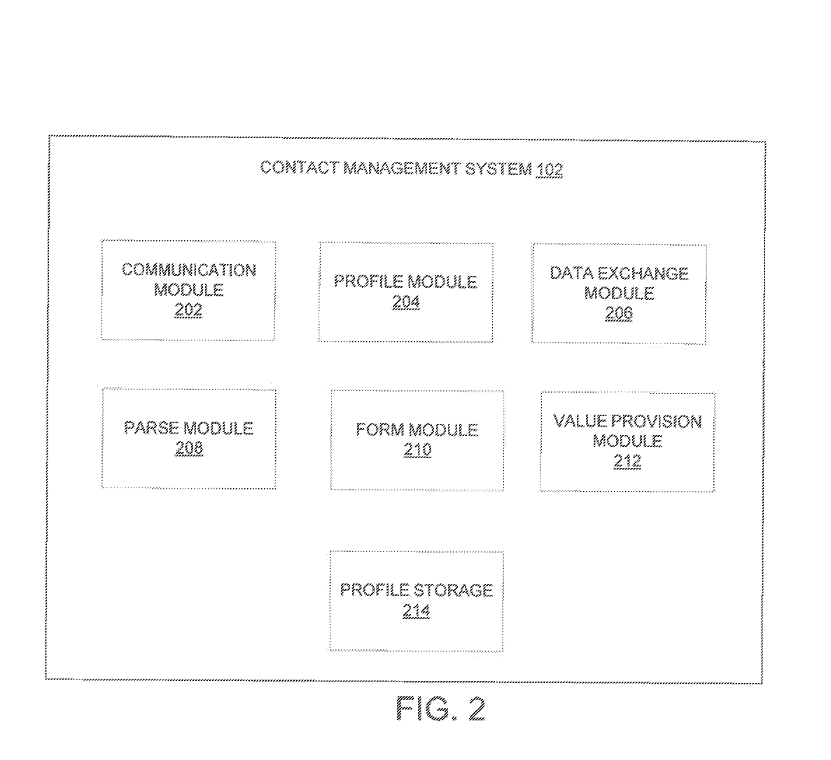

Referring now to FIG. 2, a block diagram illustrating an example embodiment of the contact management system 102 is shown. The contact management system 102 provides the management application 110 to the user devices 106 and manages the contacts in the network. To enable these operations, the contact management system 102 comprises a communication module 202, a profile module 204, a data exchange module 206, a parse module 208, a form module 210, a value provision module 212. sad a profile storage 214 coupled in communication with each other. Alternative embodiments may comprise more, less, or other modules for managing contacts in the network. Some functions of the modules may be combined or divided into two or more further modules.

The communication module 202 exchanges information with the various user devices 106. In example embodiments, the communication module 202 receives a request for contact information corresponding to an individual in an address book of a user (e.g., from the user device 106 of the user). In some embodiments, the communication module 202 may also receive instructions or indications from the individual as to which other users should automatically receive a new value in order to update their respective address books as will be discussed farther herein.

The profile module 204 determines whether the value being requested exists in a primary profile that is maintained In the profile storage 214 for the individual. As such, the profile module 204 accesses the primary profile for the Individual in the profile storage 214. Once accessed, the profile module 204 determines if the requested value exists in the primary profile for the individual. If the requested value exists in the primary profile, in example embodiments, the communication module 202 may automatically provide the value to the management application 110 of the user device 106 of the user to update the address book with the value after receiving permission from the individual.

If the requested value does not exist in the primary profile, the data exchange module 206 manages a data exchange -with the individual in order to obtain the requested value. Accordingly, the data exchange module 206 may send an electronic message to the individual, requesting the individual to provide the value. The electronic message may be sent by any means based on contact Information (e.g., values) stored in, for example, the address book of the user. For example, the electronic message may be sent via e-mail if an e-mail address exists in the contact or sent via text messaging if a mobile phone number exists in the contact or via a chat message.

However, there may be some embodiments where the electronic message may not be sent based on the request. For example, if a threshold number of electronic messages requesting the value have already been sent to the individual within a predetermined time period, the data exchange module 206 may delay (or prevent) providing any further electronic messages to the individual requesting the value. It is noted that in some embodiments, the functions of the data exchange module 206 may be performed by the communication module 202.

An electronic response from the individual may also be received and processed by the data exchange module 206. If the electronic response is a reply in the same format as the electronic message, then the reply may be sent to the parse module 208 by the data exchange module 206. The parse module 208 may then parse the value from the reply. Thus, for example, if the electronic message is an e-mail and the reply is an e-mail, the parse module 208 may parse the value from the reply e-mail. Similarly, if the electronic message is a text message and the reply is a text message, the parse module 208 may parse the value from the reply text message. In example embodiments, the parse module 208 parses the value by detecting likely elements of the value. For example, if the requested value is a phone number, the parse module 208 will search for a string of numerical values. In another example, if the requested value is an e-mail address, the parse module 208 may search for an “@” character or a domain name indicator that would be associated with an e-mail (e.g., .com; .org).

The parse module 208 also determines a country code for the value based on the value being a phone number (e.g., mobile phone number, home phone number). In some embodiments, the parse module 208 may determine the country code based on an IP address from which the reply was received. In other embodiments, the country code may be determined based on a country of the individual or country of the user requesting the value. For example, the primary profile of the individual or the contact in the address book of the user or the profile of the user may include an address for the individual or user that identifies their country. Using this information, the parse module 208 may derive the country code. In one example, the parse module 208 may search a lookup table of country codes. In yet other embodiments, the country code may be received directly from the individual as part of the value. In example embodiments, the primary profile at the contact management system 102 is then updated with the value.

Alternatively, if the electronic response is an indication of activation of a link (e.g., URL) provided in the electronic message, the data exchange module 206 triggers the form module 210 to provide a form for presentation to the individual, The form comprises a field for entering the value. In some embodiments, the activation of the link may trigger the data exchange module 206 to request the individual to authenticate their identity. The individual may authenticate their identity by using a login associated with a service through which the individual receives the electronic message. For example, the individual may be requested to authorize their Gmail identity using OAuth. The login may be performed at any time (e.g., prior to presentation of the field for entering the value, with the submission of the form). If the individual does not authenticate themselves, the value may be masked as unverified. In some embodiments, the unverified value may be provided to the user that sent the request with an indication that the value is unverified. The unverified value may not be used to update the primary profile at the contact management system 102 or be provided to any other social contacts of the individual

Upon the individual entering and submitting the value, the form module 210 receives the value via the field. In most embodiments, a country code does not need to be determined using the form since the individual may be asked to supply the country code. However, if the country code is not provided by the individual, then the form module 210 may determine the country code in a similar manner as that discussed above with respect to the parse module 208. In example embodiments, the primary profile at the contact management system 102 is then updated with the value.

The value provision module 212 manages the provisioning of the newly received value from the individual. Accordingly, the value provision module 212 automatically provides the value to the user device of the user that sent the request. Furthermore, once the primary profile is updated, social contacts of the individual (e.g., friends, colleagues, family) may automatically receive the new value in order to update their respective address books with the contact information or value. In example embodiments, the individual may provide the value provision module 212 with instructions as to which social contacts should automatically receive the new value. The instructions may be received at any time (e.g., before the notification, with the notification, or after the notification).

The profile storage 214 maintains primary profiles for all individuals registered with or using applications associated with the contact management system 102. Each individual has a primary profile in the profile storage 214 that the individual may be responsible for managing. Information in the primary profile of the individual may be copied to address books of social contacts of the individual. By doing this, the social contacts may maintain updated contact information for the individual in their respective address books. It is noted that the profile storage 214 may be a hardware storage device.

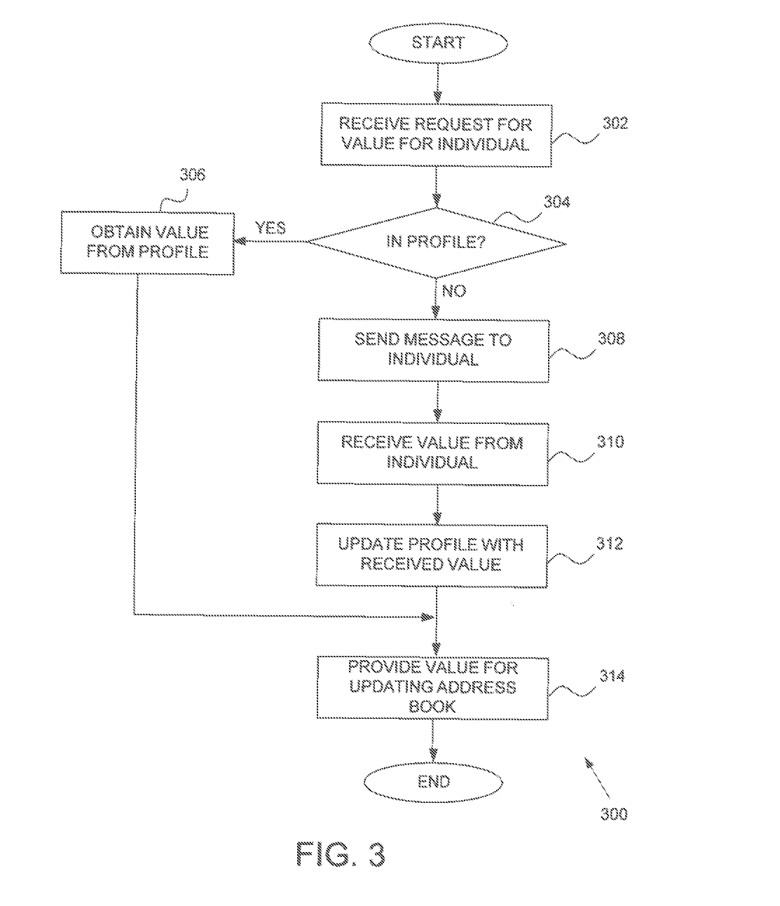

FIG. 3 is a flow diagram of an example method for managing contact Information requests in a network. In example embodiments, a request for a value is received from a user in operation 302. The request will identify the individual from whom the value is requested and a value type (e.g., a mobile number, an email address). In some embodiments, the contact in the address book is determined to correspond to the individual based on a second value in the contact that is also contained in the primary profile of the individual that uniquely identifies the individual. The second value may be any one of an e-mail address, a mobile number, a chat account, a handle, a telephone number, or a social network identifier. In example embodiments, the request is received via the network 104 and may comprise, for example, an e-mail, a text message, an SMS message, or a voice message.

In operation 304, a determination is made as to whether the value being requested exists in the primary profile for the individual. In example embodiments, the profile module 204 accesses the primary profile for the individual in the profile storage 214. The profile module 204 then determines whether the requested value exists in the primary profile. If the requested value exists in the primary profile, the value may be obtained from the primary profile in operation 306.

If the requested value does not exist in the primary profile, then in operation 308, the data exchange module 206 initiates a data exchange with a user device of the individual in order to obtain the requested value. In example embodiments, the data exchange module 206 sends an electronic message to the individual requesting the individual provide the value. The electronic message may be sent by any means based on contact information (e.g., values) stored in the address book of the user or the primary profile of the individual. In some cases, the data exchange module 206 may decide not to send the electronic message if a threshold number of electronic messages requesting the same value has been sent within a predetermined period of time. Additionally, the data exchange module 206 may provide a reminder if the individual has ignored the previous request past a timing threshold (e.g., after 1 week).

In some embodiments where the value exists in the primary profile, the individual may still be sent an electronic message by the data exchange module 206. In these embodiments, the electronic message is a request not for the value, but for approval from the individual to provide the value in the primary profile to the user.

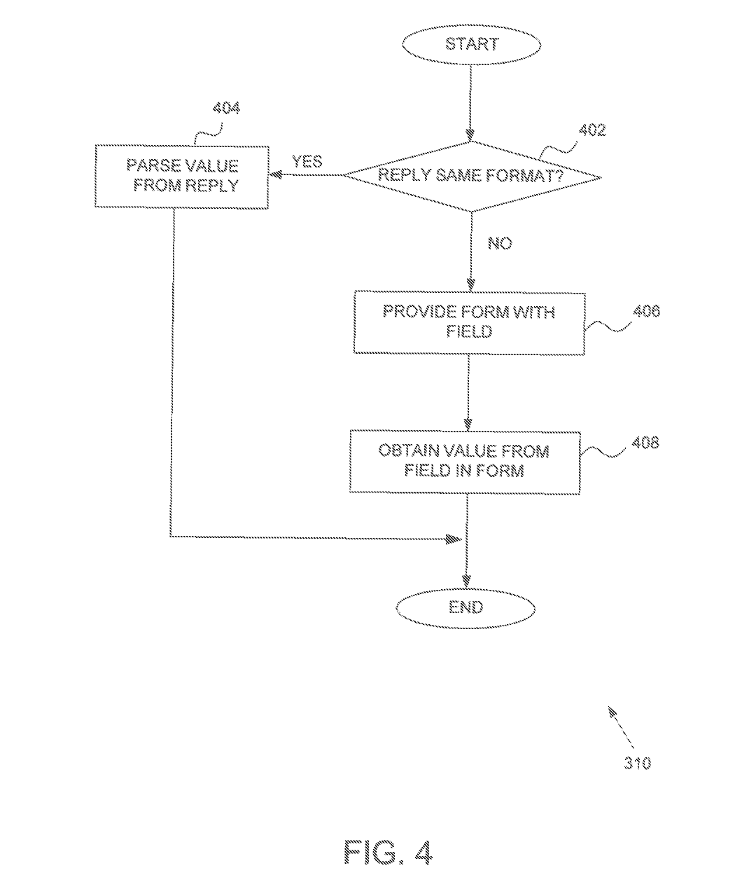

In operation 310, a value is received from the individual. The value may be received via different methods, as will be discussed in more detailed in connection with FIG. 4. The profile module 204 uses the value received in operation 310 to update, in operation 312, the primary profile for the individual in the profile storage 214 at the contact management system 102.

The value is automatically provided to the user that sent the request in operation 314 by the value provision module 212. The management application 110 on the user device of the user may then automatically update the address book of the user with the value.

FIG. 4 is a flow diagram of an example method for obtaining the contact information from an electronic response provided by an individual (operation 310). In operation 402, a determination is made as to whether the electronic response is a reply in the same format as the electronic message requesting the value from the individual. In example embodiments, the data exchange module 206 performs the determination.

If the reply is in the same format as the electronic message, the reply is parsed to obtain the value in operation 404. If the electronic response is a reply in the same format as the electronic message, then the data exchange module 206 directs the reply to the parse module 208. The parse module 208 parses the value from the reply to obtain the value.

If the reply is not In the same format as the electronic message, according to example embodiments, a form may be provided in operation 406. For example, the reply may be an indication of activation of a link (URL) provided in the electronic message. The form module 210 provides the form to be presented to the individual that includes a field for entering the value. The individual may provide the value in the field on the form and submit the form.

The value is obtained from the field in operation 408. For instance, the individual enters and submits the value. The form module 210 obtains the value from the field in the submitted form.

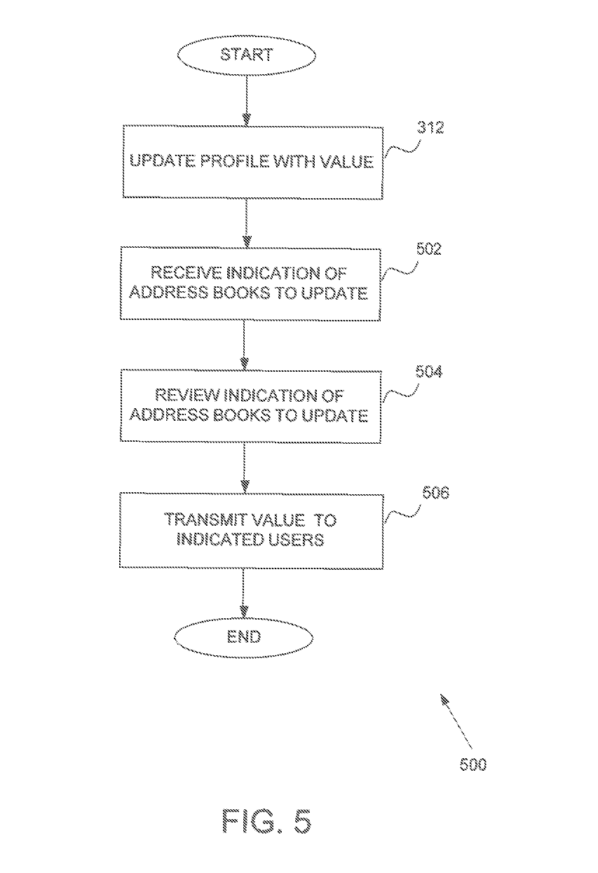

FIG. 5 is a flow diagram of an example method for provisioning obtained contact information to socially connected users. As discussed in FIG. 3, the primary profile is updated with the obtained value in operation 312. In example embodiments, the contact management system 102 is configured to automatically update address books of socially connected users of the individual. Socially connected users may comprise, for example, family, friends, or colleagues of the individual that the individual has identified to the contact management system 102. As such, in operation 502, the contact management system 102 receives an indication of socially connected users whose address books should be automatically updated. The indication establishes a permission setting at the contact management system 102. The permission setting may also comprise an indication to automatically send the value to, for example, anyone, no one, friends, a specific list of users, or a set of domain names. While the operation 502 is shown as occurring after the update of the primary profile, in various embodiments, the indication may be received at any time. For example, the individual may have set the permission setting prior to receiving the electronic message, or the individual may set the permission setting after sending the response to the electronic message.

In operation 504, an indication of which address books to update is reviewed. The indication identifies social contacts of the individuals (via the permission setting) that should automatically receive the value in order to update their respective address books.

In operation 506, the value is transmitted to the indicated users specified by the permission setting. In example embodiments, the value provision module 212 transmits the value to the proper users. The management application 110 on each user devices of these users may automatically update the address book of the user with the value.

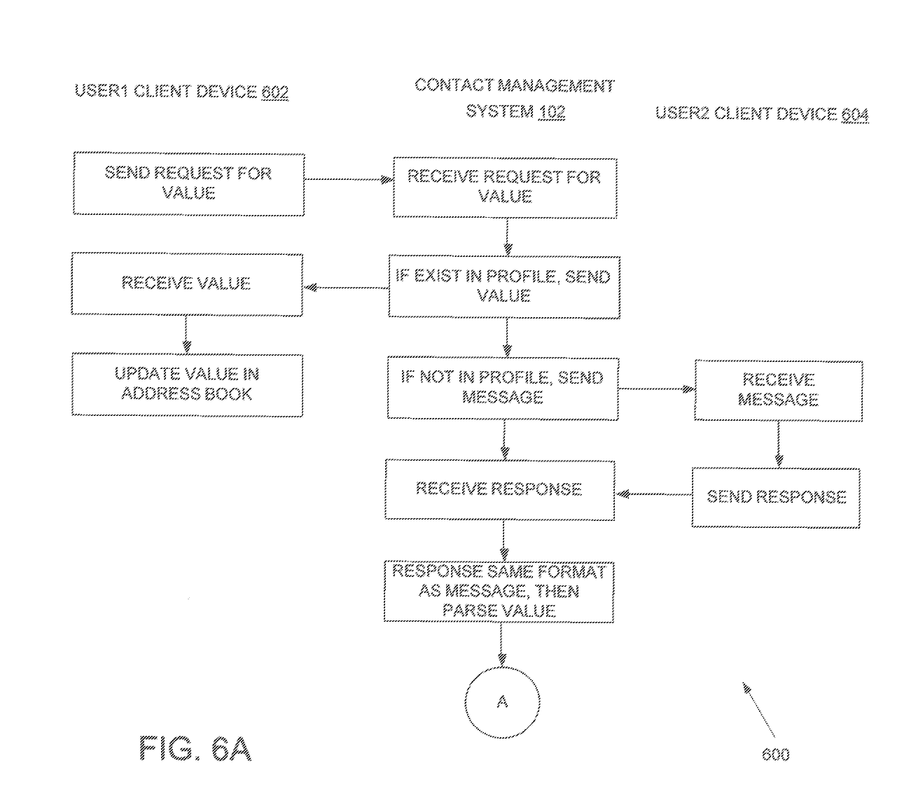

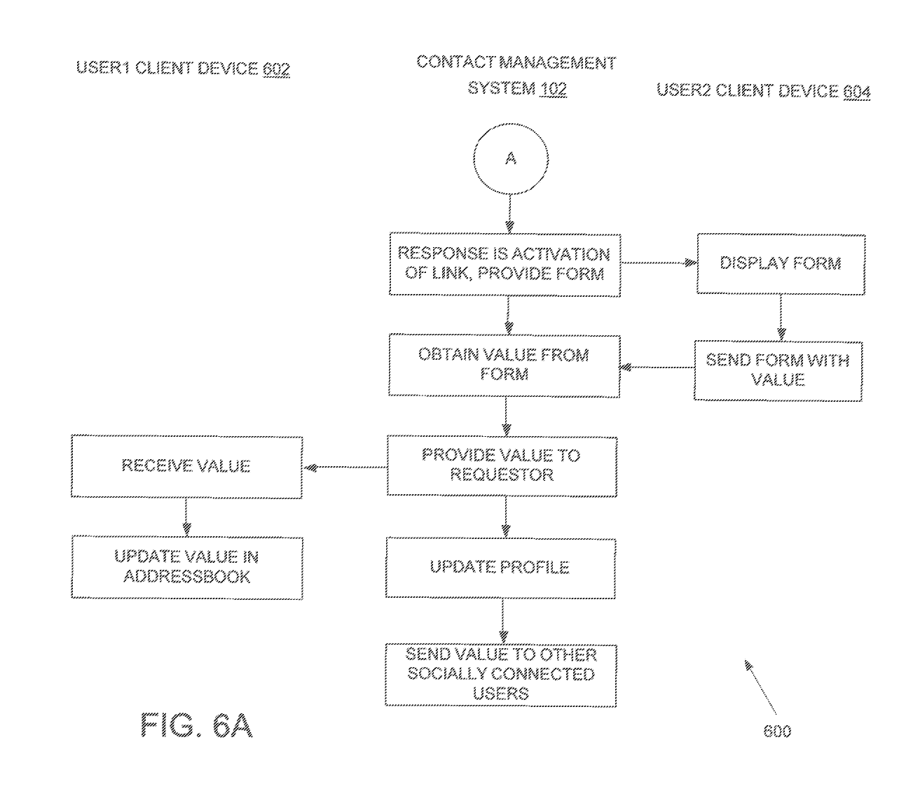

FIG. 6A and FIG. 6B are communication flow diagrams of an example method for managing contact information requests in the network. User1 at client device 602 (e.g., client device 106a) sends a request for a value for an individual (user2) that may be missing from user1's address book. The request is sent to the contact management system 102. Once received, the contact management system 102 determines if the value exists in the user2's primary profile at the contact management system 102. If the value exists, then the value is sent to the user1 client device 602. Use address book is updated with the value. In some embodiments, if user2 has requested that the value not be sent to user1, then the contact management system 102 will not send the value. Alternatively, user2 may be sent an electronic message requesting authorization to send the value from the primary profile to user1.

However, if the value is not in the primary profile of user2, an electronic message is sent to user2 at client device 604 (e.g., client device 106b). The electronic message is received by the user2 client device 604 and user2 sends an electronic response to the electronic message.

The electronic response or reply is received by the contact management system 102. If the reply is in the same format as the electronic message, then the reply is parsed to obtain the value. However, if the response is an indication of activation of a link, a form is provided to the user2 client device 604. The form is displayed so that user2 may fill in at least one field in the form. The form may then be submitted and sent to the contact management system 102. The contact management system 102 obtains the value from the field of the form. The value is then sent to the user1 client device 602 and the user 1 client device 602 may update the contact (e.g., entry) in the address book with the value.

The value may also be used to update the primary profile at the contact management system 102. In some cases, the primary profile may be updated prior to the value being sent to the user1 client device 602.

The value may also be sent to other socially connected users of the individual (user2). Permission settings at the contact management system 102 that were established by user 2 may be reviewed to determine which socially connected users should automatically receive the value. The value is transmitted to these socially connected users and their respective address books may be updated.

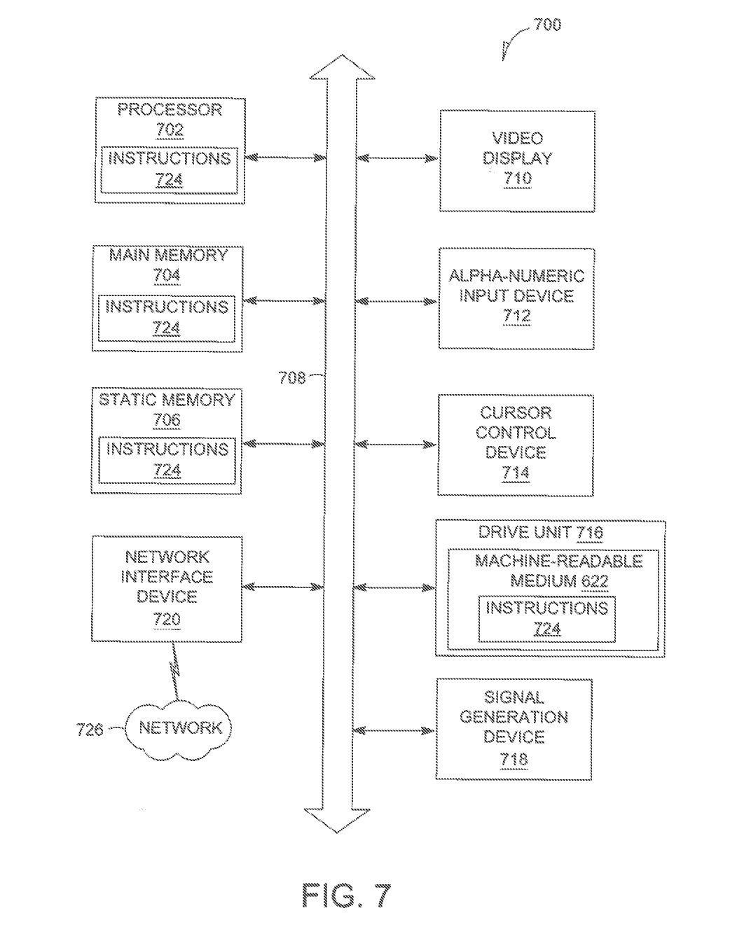

FIG. 7 is a block diagram illustrating components of a machine 700, according to some example embodiments, able to read instructions from a machine-readable medium (e.g., a machine-readable storage medium) and perform any one or more of the methodologies discussed herein. Specifically, FIG. 7 shows a diagrammatic representation of the machine 700 in the example form of a computer system and within which instructions 724 (e.g., software, a program, an application, an applet, an app, or other executable code) for causing the machine 700 to perform any one or more of the methodologies discussed herein may be executed. In alternative embodiments, the machine 700 operates as a standalone device or may be connected (e.g., networked) to other machines. In a networked deployment, the machine 700 may operate in the capacity of a server machine or a client machine in a server-client network environment, or as a peer machine in a peer-to-peer (or distributed) network environment. The machine 700 may be a server computer, a client computer, a personal computer (PC), a tablet computer, a laptop computer, a netbook, a set-top box (STB), a personal digital assistant (PDA), a cellular telephone, a Smartphone, a web appliance, a network router, a network switch, a network bridge, or any machine capable of executing the instructions 724, sequentially or otherwise, that specify actions to be taken by that machine. Further, while only a single machine is illustrated, the term “machine” shall also be taken to include a collection of machines that individually or jointly execute the instructions 724 to perform any one or more of the methodologies discussed herein.

The machine 700 includes a processor 702 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 704, and a static memory 706, which are configured to communicate with each other via a bus 708. The machine 700 may further include a graphics display 710 (e.g., a plasma display panel (PDP), a light emitting diode (LED) display, a liquid crystal display (LCD), a projector, or a cathode ray tube (CRT)), The machine 700 may also include an alphanumeric input device 712 (e.g., a keyboard), a cursor control device 714 (e.g., a mouse, a touchpad, a trackball, a joystick, a motion sensor, or other pointing instrument), a storage unit 716, a signal generation device 718 (e.g., a speaker), and a network interface device 720.

The storage unit 716 includes a machine-readable medium 722 on which is stored the instructions 724 embodying any one or more of the methodologies or functions described herein. The instructions 724 may also reside, completely or at least partially, within the main memory 704, within the processor 702 (e.g., within the processor's cache memory), or both, during execution thereof by the machine 700. Accordingly, the main memory 704 and the processor 702 may be considered as machine-readable media. The instructions 724 may be transmitted or received over a network 726 via the network interface device 720.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 722 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions for execution by a machine (e.g., machine 700), such that the instructions, when executed by one or more processors of the machine (e.g., processor 702), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

The instructions 724 may further be transmitted or received over a communications network 726 using a transmission medium via the network interface device 720 and utilizing any one of a number of well-known transfer protocols (e.g., HTTP). Examples of communication networks include a local area network (LAN), a wide area network (WAN), the Internet, mobile telephone networks, POTS networks, and wireless data networks (e.g., WiFi and WiMAX networks). The term “transmission medium” shall be taken to include any intangible medium that is capable of storing, encoding, or carrying instructions for execution by the machine, and includes digital or analog communications signals or other intangible medium to meditate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor implemented module” refers to a hardware module implemented using one or more processors,

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)),

The performance of certain of the operations may be distributed among the one or more processors, not only residing within a single machine, but deployed across a number of machines. In some example embodiments, the one or more processors or processor-implemented modules may be located in a single geographic location (e.g., within a tome environment, an office environment, or a server farm). In other example embodiments, the one or more processors or processor-implemented modules may be distributed across a number of geographic locations.

Although an overview of the inventive subject matter has been described with reference to specific example embodiments, various modifications and changes may be made to these embodiments without departing from the broader spirit and scope of embodiments of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A method comprising:
receiving, at a contact management system, a request from a user device of a user requesting a value for a contact in an address book of the user, the contact in the address book corresponding to an individual;
sending an electronic message to the Individual in response to the request;
receiving an electronic response from the individual;
based on the electronic response being a reply in a same format as the electronic message and the reply including the value, parsing, using a processor of a machine, the value from the reply;
based on the electronic response being an indication of activation of a link provided in the electronic message, causing a form to be presented to the individual with a field for entering the value, and receiving the value via the field in the form; and
causing the value obtained from the individual to be automatically added to the contact at the address book of the user.

2. The method of claim 1, further comprising updating a primary profile of the individual at the contact management system to include the value in response to the individual providing the value.

3. The method of claim 2, further comprising automatically transmitting the value that updated the primary profile to address books of socially connected users to the individual.

4. The method of claim 1, further comprising receiving, from the individual, an indication of which socially connected users are to be automatically provided the value, the indication comprising a permissions setting.

5. The method of claim 4, wherein the permissions setting comprises a selection from a group consisting of anyone, no one, friends, a specific list of users, and a set of domain names.

6. The method of claim 4, farther comprising automatically transmitting the value to address books of users indicated by the individual in the permissions setting.

7. The method of claim 1, wherein, based on the value existing in a primary profile of the individual at the contact management system, the electronic response comprises an approval by the individual to provide the value from the primary profile to the user.

8. The method of claim 1, where in the electronic message is one of a chat message, e-mail, or an SMS

9. The method of claim 1, further comprising, based on the electronic response being the indication of the activation of the link, requiring the individual to authenticate their identity.

10. The method of claim 9, wherein the Individual authenticates their identity by using a login associated with a service through which the individual receives the electronic message.

11. The method of claim 1, farther comprising determining a country code for the parsed value received in the reply based on one of an IF address from which the reply was received, a country of the individual, a country of the user, or the value.

12. A tangible computer-readable device having instructions that, when executed by one or more processors, performs operations comprising:
receiving, at a contact management system, a request from a user device of a user requesting a value for a contact in an address book of me user, the contact in the address book corresponding to an individual;
sending an electronic message to the individual in response to the request;
receiving an electronic response from the individual;
based on the electronic response being a reply in a same format as the electronic message and the reply including the value, parsing, using a processor of a machine, the value from the reply;
based on the electronic response being an indication of activation of a link provided in the electronic message, causing a form to be presented to the individual with a field for entering the value, and receiving the value via the field in the form; and
causing the value obtained from the individual to be automatically added to the contact at the address book of the user.

13. The tangible computer-readable device of claim 12, farmer comprising updating a primary profile of the individual at the contact management system to include the value in response to the individual providing the value.

14. The tangible computer-readable device of claim 13, further comprising automatically transmitting the value that updated the primary profile to address books of socially connected users to the individual.

15. The tangible computer-readable device of claim 12, wherein, based on the value existing in a primary profile of the individual at the contact management system, the response comprises an approval by the individual to provide the value from the primary profile to the user.

16. The tangible computer-readable device of claim 12, further comprising, based on the electronic response being the indication of the activation of the link, requiring the individual to authenticate their identity.

17. The tangible computer-readable device of claim 16, wherein the individual authenticates their identity by using a login associated with a service through which the individual receives the electronic message.

18. The tangible computer-readable device of claim 12, timber comprising determining a country code for the parsed value received in the reply based on one of an IP address from which the reply was received, a country of the individual, a country of the user, or the value.

19. A system comprising;
a processor of a machine;
a communication module to receive a request, from a user device of a user, requesting a value for a contact in an address book of the user, the contact in the address book corresponding to an individual;
a data exchange module to send an electronic message to the individual and to receive an electronic response from the individual in response to the request;
a parse module to parsing, using the processor of a machine, the value from the reply based on the electronic response being a reply in a same format as the electronic message and the reply including the value;
a form module to cause a form to be presented to the Individual with a field for entering the value and receiving the value via the field in the form, based on the electronic response being an indication of activation of a link provided in the electronic message; and
value provision module to cause the value obtained from the individual to be automatically added to the contact at the address book of the user.

20. The system of claim 19, wherein the response comprises an approval by the individual to provide the value from the primary profile to the user based on the value existing in a primary profile of the individual at the contact management system.
